(19) United States
(12) Patent Application Publication
(10) Pub. No.: US 2026/0148314 A1
(43) Pub. Date: May 28, 2026

(54) METHOD, DEVICE AND COMPUTER-READABLE RECORDING MEDIUM FOR PROVIDING CHATBOT SERVICE THAT OUTPUTS CUSTOMIZED FISHERY INFORMATION

(71) Applicant: Saltlux Inc., Seoul (KR)

(72) Inventors: Yong Il JEONG, Yongin-si (KR); Eun Ah KIM, Seoul (KR); Sang Min PARK, Goyang-si (KR)

(21) Appl. No.: 18/985,391

(22) Filed: Dec. 18, 2024

(30) Foreign Application Priority Data
Nov. 25, 2024 (KR) 10-2024-0170040

(51) Int. Cl. G06Q 50/02; G06Q 10/063; H04L 51/02

(52) U.S. Cl. CPC G06Q 50/02; G06Q 10/063; H04L 51/02

(57) ABSTRACT

Disclosed is a method for providing a chatbot service that outputs customized fishery information, which includes: a process start step, upon receiving a fishery-related question from a user account, of checking user information registered in the user account, and starting a service provision process for providing customized fishery information about the fishery-related question based on the checked user information; a response sentence generation step of analyzing the fishery-related question through a pre-stored AI algorithm, and applying the detailed information included in the user information as a vector weight, thereby generating a question-responding sentence for responding to the fishery-related question; and a customized fishery information provision step, when the question-responding sentence is generated and images thereof are identified, of generating customized fishery information based on the identified image and the question-responding sentence, and outputting the customized fishery information so as to be provided to the user account through the chatbot system.

### BACKGROUND OF THE INVENTION

### 1. Field of the Invention

The present invention relates to a method for providing a chatbot service that outputs customized fishery information, and more particularly, to a technology that checks user information of a user account when a fishery-related question is entered from the user account, starts a service provision process of providing customized fishery information based on the user information, analyzes the question using an artificial intelligence algorithm, generates a question-responding sentence by reflecting the user information, identifies images corresponding to the fishery-related question and the question-responding sentence, generates customized fishery information based on the images and the question-responding sentence, and provide the generated customized fishery information to the user account through a chatbot system.

### 2. Description of the Related Art

The global chatbot market size in 2024 is estimated to be approximately 7.01 billion U.S. dollars, and expected to grow at an average annual rate of 24.32% to reach 20.81 billion U.S. dollars in 2029. The growth of the chatbot market is due to increase in demand for messenger apps and changes in analyzing approaches by companies to customers. In particular, Chat GPT, which is a generative AI, emerges to show performance superior to existing rule-based chatbots, and has a trend of driving the growth of the chatbot market. In response to the above trend, companies, which have been reluctant to enter the field of generative AI due to concerns about AI problems such as information security leaks and information distortion, are actively participating in the development of generative AI recently as demands in market and consumer have surged and competition in service development has intensified. However, since problems such as malfunction, discrimination, and hate speech of chatbot have arisen in the trend, it is becoming increasingly important to ensure reliability and ethics of chatbots.

Accordingly, companies are developing technologies for utilizing chatbots in various industries by diversifying learning data for the chatbots.

As an example, Korean Patent Registration No. 10-2653266 (ARTIFICIAL INTELLIGENCE-BASED CHATBOT CONVERSATION CONSULTATION SYSTEM AND METHOD THEREOF) discloses the technology of collecting knowledge of a target domain to fine-tune an artificial intelligence algorithm.

However, the above-mentioned related art discloses only the technology that simply collects knowledge data to separate the collected knowledge data as knowledge data for embedding and knowledge data for fine-tuning and store the separated knowledge data in a database (DB), generates a custom artificial intelligent model via a training unit, and then outputs an answer responding to a question through a chatbot equipped with the artificial intelligence model based on data stored in the DB, however, does not disclose the technology that checks user information of a user account when a fishery-related question is entered from the user account, starts a service provision process of providing customized fishery information based on the user information, analyzes the question using an artificial intelligence algorithm generates a question-responding sentence by reflecting the user information, identifies images corresponding to the fishery-related question and the question-responding sentence, generates customized fishery information based on the images and the question-responding sentence, and provide the generated customized fishery information to the user account through a chatbot system. Thus, the need for a technology for solve the above problem is emerging.

### SUMMARY OF THE INVENTION

In this regard, the present invention as the invention designed to solve the above-described problems of the existing technologies checks user information of a user account when a fishery-related question is entered from the user account, starts a service provision process of providing customized fishery information based on the user information, analyzes the question using an artificial intelligence algorithm generates a question-responding sentence by reflecting the user information, identifies images corresponding to the fishery-related question and the question-responding sentence, generates customized fishery information based on the images and the question-responding sentence, and provide the generated customized fishery information to the user account through a chatbot system, thereby providing accurate information suitable for the user's demand through a chatbot, and providing visual information together to enable the user to easily understand the information.

A method implemented by a computing device including one or more processors and one or more memories for storing instructions executable in the processors to provide a chatbot service that outputs customized fishery information according to one embodiment of the present invention includes: a process start step, when a fishery-related question is received from a user account registered as a member of a fishery information provision platform, of checking user information registered in the user account, and starting a service provision process for providing customized fishery information about the fishery-related question based on the checked user information; a response sentence generation step of analyzing the fishery-related question through a pre-stored artificial intelligence algorithm when the service provision process is started, and applying the detailed information included in the user information as a vector weight, thereby generating a question-responding sentence for responding to the fishery-related question; and a customized fishery information provision step, when the question-responding sentence is completely generated, and images corresponding to the fishery-related question and the question-responding sentence are identified through the pre-stored artificial intelligence algorithm, of generating customized fishery information for the fishery-related question based on the identified image and the question-responding sentence, and outputting the customized fishery information so as to be provided to the user account through the chatbot system of the fishery information provision platform.

The process start step may include: a detailed information check step, when the fishery-related question is received from the user account, of checking environmental weather information, aquatic product growth information, marine environment information, aquatic product distribution information and aquatic product log information, which are detailed information included in the user information registered in the user account; and an analysis start step, when a function of the detailed information check step is completed, of starting a service provision process for generating and providing customized fishery information by analyzing the fishery-related question based on the checked detailed information.

The response sentence generation step may include: a first tokenization step, when the service provision process is started, of performing a tokenization process on the fishery-related question through a first model of the pre-stored artificial intelligence algorithm, and tokenizing a first sentence corresponding to the fishery-related question; and a vector value-based category identification step, when the first sentence is completely tokenized, of performing a vectorising process on the first token of the first sentence through the first model, and calculating a vector value for the first token digitized based on a position of the first token from the first sentence to calculate a vector value for the first sentence, thereby determining a category to which the first sentence is included among preset multiple categories through the calculated vector value.

The response sentence generation step may further include: a second tokenization step, when the service provision process is started, of performing a tokenization process on the detailed information included in the user information through a first model of the pre-stored artificial intelligence algorithm, and tokenizing each of second sentences corresponding to the detailed information included in the user information; and a weight calculation classification step, when each of the second sentences is tokenized, of performing a vectorising process on the second token of each of the second sentences through the first model, calculating a vector value for the second token digitized based on a position of the second token from each of the second sentences, to calculate a vector value for each of the second sentences, and classifying the vector value for each of the second sentences by a weight to be applied to the vector value of the first sentence, so as to be classified by preset multiple categories.

The preset categories refer to categories, which contain multiple reference sentences serving as candidates for responding to the fishery-related question while matching with a representative vector value for each of multiple categories, and may include reference category information updated with multiple reference sentences included in each of the categories by an administrator of the fishery information provision platform, together with the representative vector values matching with the categories.

The response sentence generation step may further include a response sentence derivation step, and the response sentence derivation step may include: a vector value analysis step, when the vector value of the first sentence and the vector value of the second sentence are calculated, of starting an analysis on the vector value of the first sentence, the vector value of the second sentence, and the vector values of the reference sentences included in the category including the first sentence by using the first model of the pre-stored artificial intelligence algorithm; a reference sentence identification step, when a function of the vector value analysis step is completed, of comparing the vector value of the first sentence with the reference vector value of each of the reference sentences included in the category including the first sentence among the preset categories, and applying the vector value of the second sentence classified by the weight to the vector value of the first sentence, so as to identify a reference sentence having a reference vector value having a high similarity to the vector value of the first sentence to which the weight is applied; and a sentence derivation completion step, when the reference sentence is completely identified, of checking a part identified as a basis for the fishery-related question in the identified reference sentence to perform a summary process of summarizing the reference sentence through the first model, and then documenting the summarized reference sentence, thereby deriving and completing a question-responding sentence for responding to the fishery-related question.

The customized fishery information provision step may include: an image information identification step, when the question-responding sentence is completely generated, of analyzing the fishery-related question and the question-responding sentence through a second model of the pre-stored artificial intelligence algorithm, so that at least one image corresponding to the result obtained by analyzing the fishery-related question and the question-responding sentence is identified among multiple image information stored in an image database; and a chatbot-based information provision step, when the image is completely identified, of generating customized fishery information including the identified image and the question-responding sentence, and providing the customized fishery information to user accounts through a chatbot system linked to the fishery information provision platform.

The pre-stored artificial intelligence algorithm may include: a first model as a large-scale language model that learns a first pattern value derived by analyzing reference sentences included in multiple preset categories, other fishery-related questions for each of the preset categories, other users information registered in other user accounts having provided other fishery-related questions, and a correlation through natural language processing of other question-responding sentences that respond to the other fishery-related questions reflecting the other user information; and a second model as an image searching model that learns a second pattern value derived by analyzing reference images included in each of the preset multiple categories, other fishery-related questions for each of the preset categories, other question-responding sentences responding to other fishery-related questions reflecting other user information, and a correlation between other images corresponding to the other fishery-related questions and the other question-responding sentences.

A method implemented by a computing device including one or more processors and one or more memories for storing instructions executable in the processors to provide a chatbot service that outputs customized fishery information according to one embodiment of the present invention includes: a process start step, when a fishery-related question is received from a user account registered as a member of a fishery information provision platform, of checking user information registered in the user account, and starting a service provision process for providing customized fishery information about the fishery-related question based on the checked user information; a response sentence generation step, when the service provision process is started, of analyzing the fishery-related question through a pre-stored artificial intelligence algorithm, so as to apply the detailed information included in the user information as a vector weight, thereby generating a question-responding sentence for responding to the fishery-related question; an image normalization execution step, when the question-responding sentence is completely generated, of identifying images corresponding to the fishery-related question and the question-responding sentence through the pre-stored artificial intelligence algorithm, and performing a normalization process on the identified image when the identified images satisfy preset tuning conditions; and a customized fishery information provision step, when the normalizing process for the image is completed, of generating customized fishery information for the fishery-related question based on the normalized image and the question-responding sentence, and outputting the customized fishery information so as to be provided to the user account through the chatbot system of the fishery information provision platform.

The process start step may include: a detailed information check step, when the fishery-related question is received from the user account, of checking environmental weather information, aquatic product growth information, marine environment information, aquatic product distribution information and aquatic product log information, which are detailed information included in the user information registered in the user account; and an analysis start step, when a function of the detailed information check step is completed, of starting a service provision process for generating and providing customized fishery information by analyzing the fishery-related question based on the checked detailed information.

The response sentence generation step may include: a first tokenization step, when the service provision process is started, of performing a tokenization process on the fishery-related question through a first model of the pre-stored artificial intelligence algorithm, and tokenizing a first sentence corresponding to the fishery-related question; and a vector value-based category identification step, when the first sentence is completely tokenized, of performing a vectorising process on the first token of the first sentence through the first model, and calculating a vector value for the first token digitized based on a position of the first token from the first sentence to calculate a vector value for the first sentence, thereby determining a category to which the first sentence is included among preset multiple categories through the calculated vector value.

The response sentence generation step may further include: a second tokenization step, when the service provision process is started, of performing a tokenization process on the detailed information included in the user information through a first model of the pre-stored artificial intelligence algorithm, and tokenizing each of second sentences corresponding to the detailed information included in the user information; and a weight calculation classification step, when each of the second sentences is tokenized, of performing a vectorising process on a second token of each of the second sentences through the first model, calculating a vector value for the second token digitized based on a position of the second token from each of the second sentences to calculate a vector value for each of the second sentences, and classifying the vector value for each of the second sentences by a weight to be applied to the vector value of the first sentence, so as to be classified by preset multiple categories.

The preset categories may are categories, which contain multiple reference sentences serving as candidates for responding to the fishery-related question while matching with a representative vector value for each of multiple categories, and include reference category information updated with multiple reference sentences included in each of the categories by an administrator of the fishery information provision platform, together with the representative vector values matching with the categories.

The response sentence generation step may further include a response sentence derivation step, and the response sentence derivation step may include: a vector value analysis step, when the vector value of the first sentence and the vector value of the second sentence are calculated, of starting an analysis on the vector value of the first sentence, the vector value of the second sentence, and the vector values of the reference sentences included in the category including the first sentence by using the first model of the pre-stored artificial intelligence algorithm; a reference sentence identification step, when a function of the vector value analysis step is completed, of comparing the vector value of the first sentence with the reference vector value of each of the reference sentences included in the category including the first sentence among the preset categories, and applying the vector value of the second sentence classified by the weight to the vector value of the first sentence, so as to identify a reference sentence having a reference vector value having a high similarity to the vector value of the first sentence to which the weight is applied; and a sentence derivation completion step, when the reference sentence is completely identified, of checking a part identified as a basis for the fishery-related question in the identified reference sentence to perform a summary process of summarizing the reference sentence through the first model, and then documenting the summarized reference sentence, thereby deriving and completing a question-responding sentence for responding to the fishery-related question.

The image normalization execution step may include: a normalizing process start step, when the image is completely identified and when an abnormal area is present within the identified image, of determining the preset tuning conditions as being satisfied and start the normalizing process; and a normalizing correction completion step, when the normalizing process is started, of identifying a pixel value distribution for the abnormal area in the image, and adjusting brightness and contrast of the identified pixel value distribution, thereby correcting the abnormal area based on the remaining normal area.

The pre-stored artificial intelligence algorithm may include: a first model as a large-scale language model that learns a first pattern value derived by analyzing reference sentences included in multiple preset categories, other fishery-related questions for each of the preset categories, other users information registered in other user accounts having provided other fishery-related questions, and a correlation through natural language processing of other question-responding sentences that respond to the other fishery-related questions reflecting the other user information; and a second model as an image searching model that learns a second pattern value derived by analyzing reference images included in each of the preset multiple categories, other fishery-related questions for each of the preset categories, other question-responding sentences responding to other fishery-related questions reflecting other user information, and a correlation between other images corresponding to the other fishery-related questions and the other question-responding sentences.

A device implemented by a computing device including one or more processors and one or more memories for storing instructions executable in the processors to provide a chatbot service that outputs customized fishery information according to one embodiment of the present invention includes: a process start unit, when a fishery-related question is received from a user account registered as a member of a fishery information provision platform, for checking user information registered in the user account, and starting a service provision process for providing customized fishery information about the fishery-related question based on the checked user information; a response sentence generation unit, when the service provision process is started, for analyzing the fishery-related question through a pre-stored artificial intelligence algorithm, and applying the detailed information included in the user information as a vector weight, thereby generating a question-responding sentence (such as answer summary, summary of related news and the like) for responding to the fishery-related question; and a customized fishery information provision unit, when the question-responding sentence is completely generated, and when images corresponding to the fishery-related question and the question-responding sentence are identified through the pre-stored artificial intelligence algorithm, for generating customized fishery information for the fishery-related question based on the identified image and the question-responding sentence, and outputting the customized fishery information so as to be provided to the user account through the chatbot system of the fishery information provision platform.

A device implemented by a computing device including one or more processors and one or more memories for storing instructions executable in the processors to provide a chatbot service that outputs customized fishery information according to one embodiment of the present invention includes: a process start unit, when a fishery-related question is received from a user account registered as a member of a fishery information provision platform, for checking user information registered in the user account, and starting a service provision process for providing customized fishery information about the fishery-related question based on the checked user information; a response sentence generation unit, when the service provision process is started, for analyzing the fishery-related question through a pre-stored artificial intelligence algorithm, and applying the detailed information included in the user information as a vector weight, thereby generating a question-responding sentence for responding to the fishery-related question; an image normalization execution unit, when the question-responding sentence is completely generated, for identifying images corresponding to the fishery-related question and the question-responding sentence through the pre-stored artificial intelligence algorithm, and performing a normalization process on the identified image when the identified images satisfy preset tuning conditions; and a customized fishery information provision unit, when the normalizing process for the image is completed, for generating customized fishery information for the fishery-related question based on the normalized image and the question-responding sentence, and outputting the customized fishery information so as to be provided to the user account through the chatbot system of the fishery information provision platform.

A computer-readable recording medium according to one embodiment of the present invention stores instructions for allowing a computing device to perform the following steps including: a process start step, when a fishery-related question is received from a user account registered as a member of a fishery information provision platform, of checking user information registered in the user account, and starting a service provision process for providing customized fishery information about the fishery-related question based on the checked user information; a response sentence generation step, when the service provision process is started, of analyzing the fishery-related question through a pre-stored artificial intelligence algorithm, and applying the detailed information included in the user information as a vector weight, thereby generating a question-responding sentence for responding to the fishery-related question; and a customized fishery information provision step, when the question-responding sentence is completely generated, and when images corresponding to the fishery-related question and the question-responding sentence are identified through the pre-stored artificial intelligence algorithm, of generating customized fishery information for the fishery-related question based on the identified image and the question-responding sentence, and outputting the customized fishery information so as to be provided to the user account through the chatbot system of the fishery information provision platform.

A computer-readable recording medium according to one embodiment of the present invention stores instructions for allowing a computing device to perform the following steps including: a process start step, when a fishery-related question is received from a user account registered as a member of a fishery information provision platform, of checking user information registered in the user account, and starting a service provision process for providing customized fishery information about the fishery-related question based on the checked user information; a response sentence generation step, when the service provision process is started, of analyzing the fishery-related question through a pre-stored artificial intelligence algorithm, and applying the detailed information included in the user information as a vector weight, thereby generating a question-responding sentence for responding to the fishery-related question; an image normalization execution step, when the question-responding sentence is completely generated, of identifying images corresponding to the fishery-related question and the question-responding sentence through the pre-stored artificial intelligence algorithm, and performing a normalization process on the identified image when the identified images satisfy preset tuning conditions; and a customized fishery information provision step, when the normalizing process for the image is completed, of generating customized fishery information for the fishery-related question based on the normalized image and the question-responding sentence, and outputting the customized fishery information so as to be provided to the user account through the chatbot system of the fishery information provision platform.

The present invention provides the method for providing a chatbot service that outputs customized fishery information, so that accurate information suitable for the user's demand can be provided, and visual information can be provided together to enable the user to easily understand the information.

In addition, customized fishery information can be provided in real time through the chatbot, so that answers wanted by the user can be provided regardless of time.

### BRIEF DESCRIPTION OF THE DRAWINGS

FIG. 1 is a flowchart for explaining a method for providing a chatbot service that outputs customized fishery information according to one embodiment of the present invention.

FIG. 2 is a flowchart for explaining a start step in a process of the method for providing a chatbot service that outputs customized fishery information according to one embodiment of the present invention.

FIG. 3 is a block diagram for explaining a response sentence generation unit of a device for providing a chatbot service that outputs customized fishery information according to one embodiment of the present invention.

FIG. 4 is another block diagram for explaining the response sentence generation unit of the device for providing a chatbot service that outputs customized fishery information according to one embodiment of the present invention.

FIG. 5 is a flowchart for explaining a response sentence derivation step of the method for providing a chatbot service that outputs customized fishery information according to one embodiment of the present invention.

FIG. 6 is a flowchart for explaining a customized fishery information provision step of the method for providing a chatbot service that outputs customized fishery information according to one embodiment of the present invention.

FIG. 7 is a block diagram for explaining the method for providing a chatbot service that outputs customized fishery information according to one embodiment of the present invention.

FIG. 8 is a flowchart for explaining an image normalization processing step of the method for providing a chatbot service that outputs customized fishery information according to one embodiment of the present invention.

FIG. 9 is a diagram for explaining an example of an internal configuration of a computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific exemplary aspects among one or more aspects. However, the aspects are merely exemplary and some of various ways among principles of the various aspects may be employed, and the descriptions set forth herein are intended to include all the various aspects and equivalents thereof.

The terms “embodiment”, “example”, “aspect” and the like used in the present specification may not be construed in that an aspect or design set forth herein is preferable or advantageous than other aspects or designs.

In addition, the terms “include” and/or “comprise” specify the presence of the corresponding feature and/or component, but do not preclude the possibility of the presence or addition of one or more other features, components or combinations thereof.

In addition, The terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in the embodiments of the present invention, unless otherwise defined, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in an embodiment of the present invention.

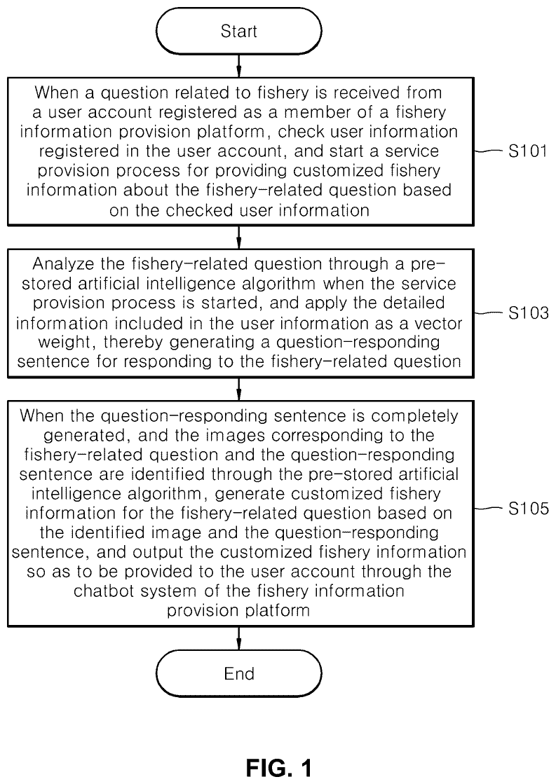

FIG. 1 is a flowchart for explaining a method for providing a chatbot service that outputs customized fishery information according to one embodiment of the present invention.

Referring to FIG. 1, a method implemented by a computing device including one or more processors and one or more memories for storing instructions executable in the processors to provide a chatbot service that outputs customized fishery information may include a process start step (step S101), a response sentence generation step (step S103) and a customized fishery information provision step (step S105).

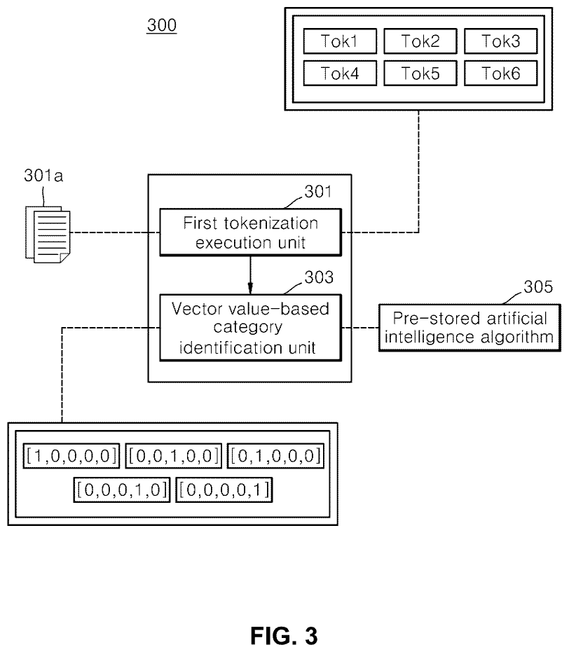

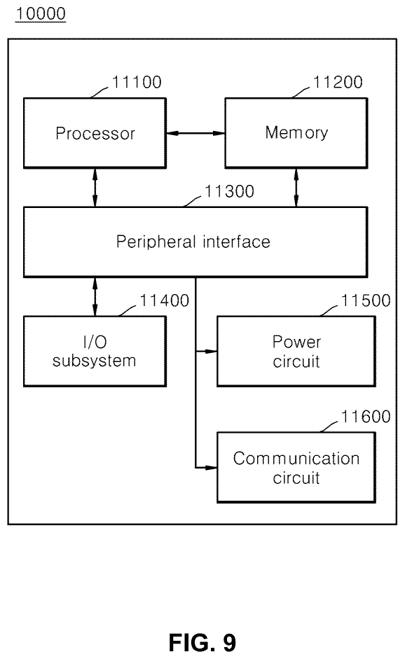

In the following description, a method to provide a chatbot service that outputs customized fishery information according to each embodiment of the present invention will be understood as being performed by a device for providing a chatbot service that outputs customized fishery information according to each embodiment of the present invention shown in FIGS. 3, 4 and 7 described later (hereinafter referred to as ‘device of the present invention’) and/or a computing device shown in FIG. 9. In other words, the device of the present invention will be understood as being implemented by combining one or more computing device of FIG. 9.

In step S101, when a fishery-related question is received from a user account registered as a member of a fishery information provision platform, the at least one processor (hereinafter referred to as “processor”) may check user information registered in the user account, and start a service provision process for providing customized fishery information about the fishery-related question based on the checked user information.

According to one embodiment, the fishery information provision platform may be a platform pre-linked with a chatbot system to provide customized fishery information to users registered as members through a chatbot of the chatbot system.

According to one embodiment, when the fishery-related question is received from the user account, the processor may check user information registered in the user account.

In this regard, the user information refers to information containing detailed information written by the user of the user account, and may be information including environmental weather information (such as temperature, humidity, precipitation and sunlight in an aquaculture area), aquatic product growth information (such as growth rate, size and number of fish) marine environment information (such as water temperature, salinity and tidal current), aquatic product distribution information (such as sales price and sales volume) and aquatic product log information (record on details of aquaculture work, time, weather, harvest volume, and the like).

According to one embodiment, when the user information is checked, the processor may perform a service provision process that analyzes the fishery-related question received from the user account based on the detailed information contained in the checked user information to provide customized fishery information.

According to one embodiment, the service provision process may be a process for providing a service that outputs the customized fishery information to a user account through a chatbot.

According to one embodiment, when the service provision process is started, the processor may perform the response sentence generation step (step S103).

In step S103, when the service provision process is started, the processor may analyze the fishery-related question through a pre-stored artificial intelligence algorithm, and apply the detailed information included in the user information as a vector weight, thereby generating a question-responding sentence for responding to the fishery-related question.

According to one embodiment, when the service provision process is started, the processor may analyze the fishery-related question through the pre-stored artificial intelligence algorithm.

According to one embodiment, the processor may analyze the fishery-related question through the pre-stored artificial intelligence algorithm to calculate a vector value for the fishery-related question.

The processor may convert the detailed information contained in the user information into a vector weight through the pre-stored artificial intelligence algorithm, and apply the vector weight to the vector value of the fishery-related question.

In other words, the processor may analyze the fishery-related question based on the detailed information contained in the user information, thereby generating a question-responding sentence for the fishery-related question based on the detailed information contained in the user information.

In this regard, the question-responding sentence refers to a sentence for responding to the fishery-related question based on the detailed information contained in the user information, and may be a sentence that summarizes an answer or related news obtained through the pre-stored artificial intelligence algorithm.

According to one embodiment, when the question-responding sentence is completely generated, the processor may perform a fishery information provision step (step S105).

In step S105, when the question-responding sentence is completely generated, and images corresponding to the fishery-related question and the question-responding sentence are identified through the pre-stored artificial intelligence algorithm, the processor may generate customized fishery information for the fishery-related question based on the identified image and the question-responding sentence, and output the customized fishery information so as to be provided to the user account through the chatbot system of the fishery information provision platform.

According to one embodiment, when the question-responding sentence is completely generated, the processor may analyze the fishery-related question and the question-responding sentence through the pre-stored artificial intelligence algorithm.

More particularly, the processor may analyze the fishery-related question and the question-responding sentence through the pre-stored artificial intelligence algorithm, so as to identify an image including an object that contains characteristics of a target corresponding to keywords included in the fishery-related question and the question-responding sentence.

According to one embodiment, when the image is completely identified, the processor may generate customized fishery information including the identified image and the question-responding sentence. The generated customized fishery information may be information including a content and an image generated based on a result obtained by analyzing the fishery-related question based on the user information.

According to one embodiment, when the customized fishery information is completely generated, the processor may output the generated customized fishery information through the chatbot of a chatbot system pre-linked to the fishery information provision platform, thereby providing the content and the image based on the customized fishery information to the user account.

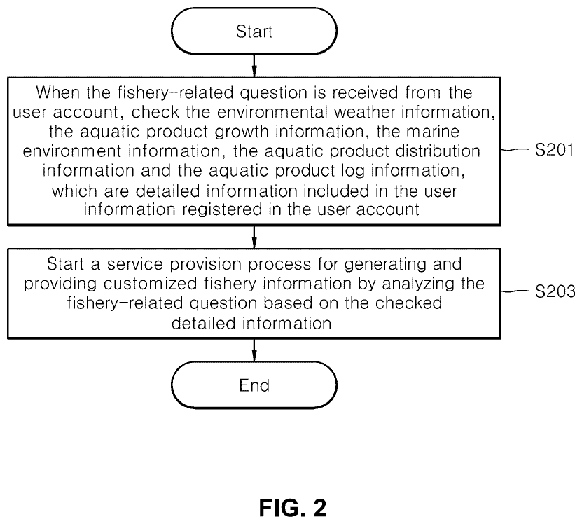

FIG. 2 is a flowchart for explaining a start step in a process of the method for providing a chatbot service that outputs customized fishery information according to one embodiment of the present invention.

Referring to FIG. 2, a method implemented by a computing device including one or more processors and one or more memories for storing instructions executable in the processors to provide a chatbot service that outputs customized fishery information may include a process start step (ex: a process start step of FIG. 1 (step S101)).

According to one embodiment, the process start step may be a step in which, when a fishery-related question is received from a user account registered as a member of a fishery information provision platform, user information registered in the user account is checked to start a service provision process for providing customized fishery information about the fishery-related question based on the checked user information.

According to one embodiment, the process start step may include a detailed information check step (step S201) and an analysis start step (step S203), as detailed steps for performing the above-described functions.

In step S201, when the fishery-related question is received from the user account, the at least one processor (hereinafter referred to as “processor”) may check the environmental weather information, the aquatic product growth information, the marine environment information, the aquatic product distribution information and the aquatic product log information, which are detailed information included in the user information registered in the user account.

According to one embodiment, the user information refers to information recorded and created by the user of the user account and may include environmental weather information, aquatic product growth information, marine environment information, aquatic product distribution information and aquatic product log information.

In this regard, the environmental weather information may be information including temperature, humidity, precipitation, sunlight and the like in an aquaculture area (or fishery area), the aquatic product growth information may be information including growth rates, sizes, numbers and the like of aquatic products as the subject of aquaculture or fishery, the marine environment information may be information including water temperature, salinity, tidal current and the like of the aquaculture area (or fishery area), the aquatic product distribution information may be information including sales prices, sales volumes, distribution routes and the like of the aquatic products, and the aquatic product log information may be information recorded about aquaculture (or fishery) work for the aquatic products, which are the subject of aquaculture or fishery, time and weather of the work, daily harvest volume, and the like.

According to one embodiment, when the user information included in the user information is completely checked, the processor may start the analysis start step (step S203).

In step S203, when the function of the detailed information check step (step S201) is completed, the processor may start a service provision process of analyzing the fishery-related question to generate and provide customized fishery information.

According to one embodiment, when the detailed information included in the user information is completely checked by performing the function of the detailed information check step (step S201), the processor may start a service provision process of analyzing the fishery-related question based on the checked detailed information through the pre-stored artificial intelligence algorithm to generate and provide customized fishery information to the user account.

FIG. 3 is a block diagram for explaining a response sentence generation unit of a device for providing a chatbot service that outputs customized fishery information according to one embodiment of the present invention.

Referring to FIG. 3, the device implemented by a computing device including one or more processors and one or more memories for storing instructions executable in the processors to provide a chatbot service that outputs customized fishery information may include a response sentence generation unit 300 (ex: performing the same function as the response sentence generation step (step S103) of FIG. 1).

According to one embodiment, when the service provision process is started a the process start unit (ex: performing the same function as the process start step (step S101) of FIG. 1), the response sentence generation unit 300 may analyze the fishery-related question 301a through the pre-stored artificial intelligence algorithm 305, and apply the detailed information included in the user information as a vector weight, thereby generating a question-responding sentence for responding to the fishery-related question.

According to one embodiment, the response sentence generation unit 300 may include a first tokenization execution unit 301 and a vector value-based category identification unit 303 as detailed configurations for performing the above-described functions.

According to one embodiment, when the service provision process is started, the first tokenization execution unit 301 may perform a tokenization process on the fishery-related question 301a through a first model of the pre-stored artificial intelligence algorithm 305, so as to tokenize a first sentence corresponding to the fishery-related question 301a.

According to one embodiment, the first tokenization execution unit 301 may perform natural language processing on the fishery-related question 301a through the first model of the pre-stored artificial intelligence algorithm 305, so as to completely identify the first sentence which is a sentence corresponding to the fishery-related question 301a.

According to one embodiment, when the first sentence is completely identified, the first tokenization execution unit 301 may perform the tokenization process on the first sentence.

In this regard, when the tokenization process is process, the first tokenization execution unit 301 may perform morpheme tokenization instead of word tokenization because Korean, unlike English, is an agglutinative language in which morphemes are not generally composed solely of independent words. The first tokenization execution unit 301 may recognize multiple morphemes included in the first sentence corresponding to the fishery-related question sentence and types of the morphemes, distinguish types of the morphemes, recognizing a combination of free morphemes and bound morphemes as one token, and designate the one token as one keyword.

The first tokenization execution unit 301 may recognize the keyword as one token or recognize one morpheme as one token.

According to one embodiment, when the first sentence is completely tokenized, the vector value-based category identification unit 303 may perform a vectorising process on the first token of the first sentence through the first model, and calculate a vector value for the first token digitized based on a position of the first token from the first sentence to calculate a vector value for the first sentence, thereby determining a category, to which the first sentence is included among preset multiple categories, through the calculated vector value.

According to one embodiment, when the function of the first tokenization execution unit 301is completed, the vector value-based category identification unit 303 may apply the tokens of the tokenized morphemes to the first model of the pre-stored artificial intelligence algorithm to perform a vectorizing process on the tokens, thereby digitizing an occurring frequency of each of the tokens and a position within the sentence, so that a vector value for each of the tokens may be calculated.

According to one embodiment, the vectorising process may be a process performed through at least one of a Bag of Words (BoW) model, a TF-IDF model, a Word2Vec model, a GloVe model, and a BERT model. The above models may be some of models included in previously stored large-scale language artificial intelligence algorithms.

In this regard, the Bag of Words (BoW) model refers to a model that vectorizes words based on the frequency, and may be a model that, for example, extracts the words “1”, “aquafarm”, “abalone”, “growth”, “rate” and “Tell me” from the sentence “Tell me the growth rate of abalone in aquafarm 1”, and calculates and vectorizes the frequency of each word.

In addition, the TF-IDF model refers to a model that complements the shortcomings of BoW, and may be a model that vectorizes words by considering both the frequency of words and the importance of document and gives higher weight to words having the more importance in the document. Further, the Word2Vec model refers to a model that learns the similarity of words and vectorizes the words, and may obtain more accurate results than BoW or TF-IDF because vectors are generated by considering the context of the words.

In addition, the GloVe model refers to a model that vectorizes words by learning the similarity, similar to Word2Ve, however, may be a model that learns using large-scale text data, unlike Word2Vec. Finally, the BERT model refers to a scheme of vectorizing sentences using a Transformer model, in which vectors are generated by considering the context to obtain more accurate results than Word2Vec or GloVe, and accordingly, may be commonly used.

According to one embodiment, when the vector value for the first sentence is completely calculated, the vector value-based category identification unit 303 may perform a similarity calculation process between the calculated vector value and a representative vector value matching with each of preset multiple categories, check which one of the preset categories is most similar to the first sentence, and classify the first sentence as the one of the preset categories having the highest similarity to the first sentence.

More particularly, the vector value-based category identification unit 303 may normalize the vector value of the first sentence through the first model of the pre-stored artificial intelligence algorithm 305, calculate a similarity by comparing the normalized the vector value with the representative vector values matching with the preset multiple categories through similarity measurement schemes such as cosine similarity, Euclidean distance and Manhattan distance, and then identify the category having the representative vector value most similar to the vector value of the first sentence among the preset multiple categories by using the calculated similarity.

In this regard, the preset categories refer to a categories, which contain multiple reference sentences serving as candidates for responding to the fishery-related question while matching with a representative vector value for each of multiple categories, and may be reference category information updated with multiple reference sentences included in each of the categories by an administrator of the fishery information provision platform, together with the representative vector values matching with the categories.

In this regard, the representative vector value matching with each of the preset categories may be an average value of vector values of the reference sentences included in each of the preset categories.

For example, among the preset categories, a first category may be a category related to the growth of abalone and contain articles, papers and the like about the growth of abalone to serve as the reference sentences, and a second category may be a category related to the weather for abalone farms and contain articles, papers and the like about the impact of weather on abalone aquaculture to serve as the reference sentences.

According to one embodiment, the first model of the pre-stored artificial intelligence algorithm may be a model that learns a first pattern value derived by analyzing reference sentences included in multiple preset categories, other fishery-related questions for each of the preset categories, other users information registered in other user accounts having provided other fishery-related questions, and a correlation through natural language processing of other question-responding sentences that respond to the other fishery-related questions reflecting the other user information.

In this regard, the first model refers to a deep learning algorithm, as a large language model (LLM), which can recognize, summarize, translate, predict, and generate text and various contents based on knowledge acquired from large data sets, and may be a more accurate algorithm than existing machine learning algorithms because the model can understand the complexity of natural language by using an advanced artificial intelligence technology that focuses on understanding and analyzing text.

In this regard, LLM is a neural network architecture having revolutionized natural language processing (NLP) tasks, and may be a comprehensive algorithm including a tokenization that divides input text into smaller units such as words or subwords, an encoder that processes and expresses an input sentence into a vector form (ex: vectorization), a decoder that generates an output sentence using the vector output from the encoder, a loss function that is a function used to train the model to measure a difference between the output sentences generated by the model and the actual sentence, and a learning algorithm that adjusts parameters of the model to minimize the loss function.

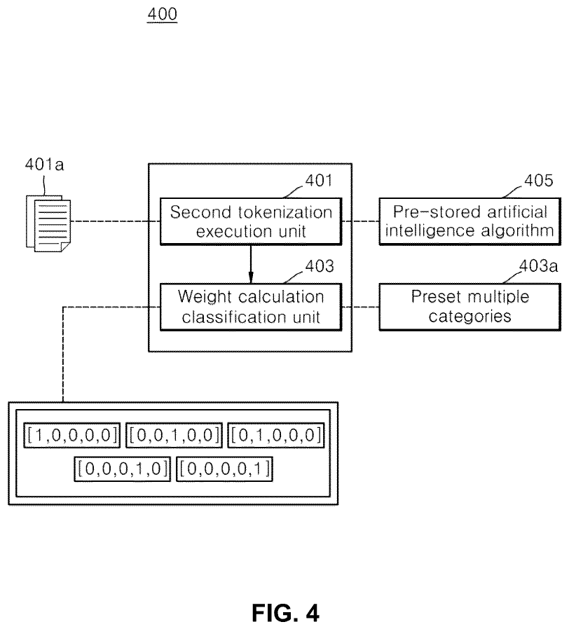

FIG. 4 is another block diagram for explaining the response sentence generation unit of the device for providing a chatbot service that outputs customized fishery information according to one embodiment of the present invention.

Referring to FIG. 4, the device implemented by a computing device including one or more processors and one or more memories for storing instructions executable in the processors to provide a chatbot service that outputs customized fishery information may include a response sentence generation unit 300 (ex: performing the same function as the response sentence generation step (step S103) of FIG. 1).

According to one embodiment, when the service provision process is started a the process start unit (ex: performing the same function as the process start step (step S101) of FIG. 1), the response sentence generation unit 400 may analyze the fishery-related question 401a through the pre-stored artificial intelligence algorithm 405, and apply the detailed information included in the user information as a vector weight, thereby generating a question-responding sentence for responding to the fishery-related question.

According to one embodiment, the response sentence generation unit 400 may include a second tokenization execution unit 401 and a weight calculation classification unit 403 as detailed configurations for performing the above-described functions.

According to one embodiment, when the service provision process is started, the second tokenization execution unit 401 may perform a tokenization process on the detailed information included in the user information through a first model of the pre-stored artificial intelligence algorithm 405, and tokenize each of second sentences corresponding to the detailed information included in the user information.

According to one embodiment, the detailed information contained in the user information is information written and generated by the user of the user account, and the second tokenization execution unit 401 may perform natural language processing on the detailed information included in the user information through the first model.

According to one embodiment, the second tokenization execution unit 401 may perform natural language processing on the detailed information included in the user information through the first model, so that the second sentences, which are sentences corresponding to the detailed information included in the user information, can be identified.

According to one embodiment, when the second sentences, which are sentences corresponding to the detailed information included in the user information, are completely identified, the second tokenization execution unit 401 may perform a tokenization process on the identified second sentences.

The second tokenization execution unit 401 may recognize keywords constituting each of the second sentences as one token or recognize one morpheme as one token.

According to one embodiment, when each of the second sentences is tokenized, the weight calculation classification unit 403 may perform a vectorising process on the second token of each of the second sentences through the first model, calculate a vector value for the second token digitized based on a position of the second token from each of the second sentences, thereby calculating a vector value for each of the second sentences, and classify the vector value for each of the second sentences by a weight to be applied to the vector value of the first sentence, so as to be classified by preset multiple categories.

According to one embodiment, the weight calculation classification unit 403 may perform a vectorising process on the second token of each of the second sentences through the first model.

Accordingly, the weight calculation classification unit 403 may calculate the vector value for the second token included in each of the second sentences by digitizing the position in each of the second sentences, thereby completing the calculation of the vector value for each of the second sentences.

The vector value of each of the calculated second sentences serves as a weight applied to the vector value of the first sentence, and may be classified into the preset multiple categories, in which the similarity between the vector value of each of the second sentences and the representative vector value matching with each of the preset categories is compared to classify each of the second sentences into each of the preset categories.

More particularly, the weight calculation classification unit 403 may normalize the vector values of the second sentences, calculate a similarity by comparing the normalized the vector value with the representative vector values matching with the preset multiple categories through similarity measurement schemes such as cosine similarity, Euclidean distance and Manhattan distance, and then classify each of the second sentences into the preset categories through the calculated similarity.

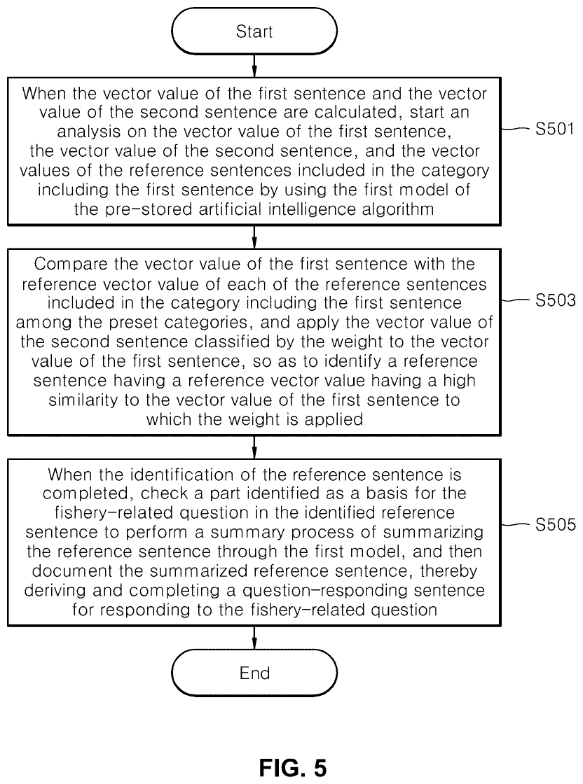

FIG. 5 is a flowchart for explaining a response sentence derivation step of the method for providing a chatbot service that outputs customized fishery information according to one embodiment of the present invention.

Referring to FIG. 5, a method implemented by a computing device including one or more processors and one or more memories for storing instructions executable in the processors to provide a chatbot service that outputs customized fishery information may include a response sentence derivation step (ex: a process start step of FIG. 1 (step S101)).

According to one embodiment, the response sentence derivation step may be a detailed step included in a response sentence generation step (ex: a response sentence generation step (step S103) of FIG. 1) including a first tokenization execution step (ex: performing the same function as the first tokenization execution unit 301 of FIG. 3), a vector value-based category identification step (ex: performing the same function as the vector value-based category identification unit 303 of FIG. 3), a second tokenization execution step (ex: performing the same function as the second tokenization execution unit 401 of FIG. 4), and a weighting calculation classification step (ex: performing the same function as the weight calculation classification unit 403 of FIG. 4).

According to one embodiment, the response sentence derivation step may be a step performed when the functions of the vector value-based category identification step and the weight calculation classification step are completed.

According to one embodiment, the response sentence derivation step may include a vector value analysis step (step S501), reference sentence identification step (step S503), and sentence derivation completion step (step S505) as detailed steps for performing the above-described functions.

In step S2501, when the vector value of the first sentence and the vector value of the second sentence are calculated, the at least one processor (hereinafter referred to as “processor”) may start an analysis on the vector value of the first sentence, the vector value of the second sentence, and the vector values of the reference sentences included in the category including the first sentence by using the first model of the pre-stored artificial intelligence algorithm.

According to one embodiment, when the functions of the vector value-based category identification step and the weight calculation classification step are completed, the processor may start an analysis on the vector value of the first sentence, the vector value of each of the second sentences, and the vector values of the reference sentences included in the category including the first sentence by using the first model.

The scheme of the analysis by the processor on the vector value of the first sentence, the vector value of each of the second sentences, and the vector values of the reference sentences included in the category including the first sentence may be performed through the analysis by comparing the similarity between the vector values of the sentences or utilizing an evaluation index included in the first model.

According to one embodiment, when the analysis on the vector value of the first sentence, the vector value of each of the second sentences, and the vector values of the reference sentences included in the category including the first sentence is started by using the first model, the processor may perform the reference sentence identification step (step S503).

In step S503, when the function of the vector value analysis step (step S501) is completed, the processor may compare the vector value of the first sentence with the reference vector value of each of the reference sentences included in the category including the first sentence among the preset categories, and apply the vector value of the second sentence classified by the weight to the vector value of the first sentence, so as to identify a reference sentence having a reference vector value having a high similarity to the vector value of the first sentence to which the weight is applied.

According to one embodiment, when the analysis on the vector value of the first sentence, the vector value of each of the second sentences, and the vector values of the reference sentences included in the category including the first sentence is started by using the first model, the processor may identify the reference vector value of each of the reference sentences included in the category including the first sentence among the preset categories.

According to one embodiment, when the reference vector value of each of the reference sentences included in the category including the first sentence is identified, the processor may apply the vector value of the second sentence to the vector value of the first sentence, thereby performing a similarity comparison process between the vector value of the first sentence to which the vector value of the second sentence is applied and the reference vector value of each of the reference sentences included in the category including the first sentence.

According to one embodiment, based on the results obtained by performing the similarity comparison process, the processor may complete identifying a reference sentence having a vector value with the highest similarity to the vector value of the first sentence to which the vector value of the second sentence is applied among the reference sentences included in the category including the first sentence.

According to another embodiment, when the vector value of the second sentence classified by the weight is applied to the vector value of the first sentence, and a reference sentence having a reference vector value having a high similarity to the vector value of the first sentence to which the weight is applied is identified, the processor may complete the identification of the reference sentence based on the evaluation index included in the first model other than the similarity comparison process.

In this regard, the evaluation index may include Bilingual evaluation understudy (BLEU), Recall-oriented understudy for gitting evaluation (ROUGE), Metric for evaluation of translation with explicit ordering (METEOR), Perplexity, Accuracy, F1 Score, and Human Judgment.

According to one embodiment, when the reference sentence having the reference vector value having the high similarity to the vector value of the first sentence to which the weight is applied is completely identified, the processor may perform the sentence derivation completion step (step S505).

In step S505, when the reference sentence is completely identified, the processor may check a part identified as a basis for the fishery-related question in the identified reference sentence, perform a summary process of summarizing the reference sentence through the first model, and then document the summarized reference sentence, thereby deriving and completing a question-responding sentence for responding to the fishery-related question.

According to one embodiment, when the reference sentence having the reference vector value having the high similarity to the vector value of the first sentence to which the weight is applied is completely identified, the processor may check the part identified as the basis for the fishery-related question in the identified reference sentence.

The processor may identify a correlation between keywords constituting the fishery-related question through the first model, and identify keywords included in the identified correlation from the reference sentence, thereby checking keywords based on the keywords included in the identified correlation in the reference sentence.

According to one embodiment, after checking the part of the reference sentence identified as the basis for the fishery-related question, the processor may perform the summary process of summarizing the reference sentence through the first model.

In this regard, the processor may execute normalization, through the above first model, along with the tokenization process for papers and news articles based on the reference sentences, so as to perform a summarizing process for maintaining consistency in grammar, vocabulary and meaning of the papers and the news articles. The result obtained by completing the summary process may include a result that includes a part identified as a basis for the fishery-related question.

According to one embodiment, when the summary process is completed, the processor may document the summarized reference sentence including the part identified as the basis for the fishery-related question, so as to be derived as a question-responding sentence.

The question-responding sentence derived (or generated) by documenting the reference sentence may be a sentence in which the fishery-related question and the response sentence therefor are matched and grouped with each other.

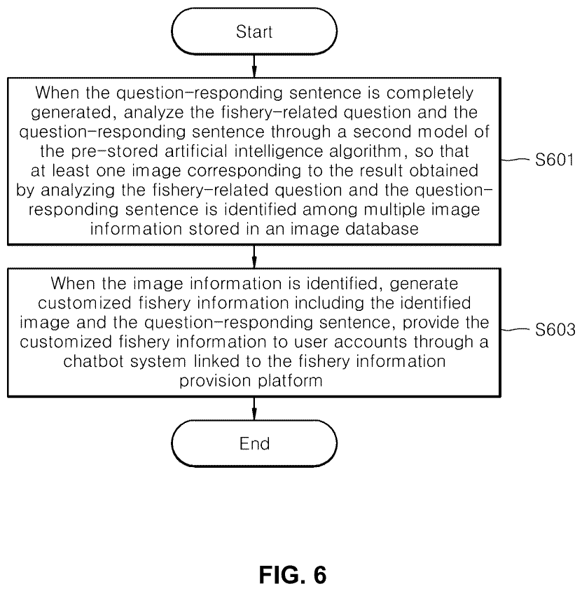

FIG. 6 is a flowchart for explaining a customized fishery information provision step of the method for providing a chatbot service that outputs customized fishery information according to one embodiment of the present invention.

Referring to FIG. 6, a method implemented by a computing device including one or more processors and one or more memories for storing instructions executable in the processors to provide a chatbot service that outputs customized fishery information may include a customized fishery information provision step (ex: the customized fishery information provision step (step S105) in FIG. 1).

According to one embodiment, the customized fishery information provision step may be a step in which, when the question-responding sentence is completely generated, and the images corresponding to the fishery-related question and the question-responding sentence are identified through the pre-stored artificial intelligence algorithm, customized fishery information for the fishery-related question is generated based on the identified image and the question-responding sentence, so that the customized fishery information is output so as to be provided to the user account through the chatbot system of the fishery information provision platform.

According to one embodiment, the customized fishery information provision step may include an image information identification step (step S601) and a chatbot-based information provision step (step S603) as detailed steps for performing the above-described functions.

In step S601, when the question-responding sentence is completely generated, the at least one processor (hereinafter referred to as “processor”) may analyze the fishery-related question and the question-responding sentence through a second model of the pre-stored artificial intelligence algorithm, so that at least one image corresponding to the result obtained by analyzing the fishery-related question and the question-responding sentence may be identified among multiple image information stored in an image database.

According to one embodiment, when the question-responding sentence is completely generated, the processor may analyze the fishery-related question and the question-responding sentence through the second model of the pre-stored artificial intelligence algorithm, so that an image corresponding to the analysis result may be identified among multiple image information stored in the image database.

More particularly, the processor may identify images including objects corresponding to keywords included in each of the fishery-related question and each of the question-responding sentence from multiple images stored in the image database.

According to one embodiment, the first model of the pre-stored artificial intelligence algorithm may be a model that learns a second pattern value derived by analyzing reference images included in each of the preset multiple categories, other fishery-related questions for each of the preset categories, other question-responding sentences responding to other fishery-related questions reflecting other user information, and a correlation between other images corresponding to the other fishery-related questions and the other question-responding sentences.

In this regard, the second pattern value may be a pattern value that calculates the similarity by comparing feature vector values of images with vector values of sentences, and may be a pattern value that identifies an image including an object corresponding to a keyword included in a sentence.

According to one embodiment, when the image is completely identified, the processor may perform the chatbot-based information provision step (step S603).

In step S603, when the image is completely identified, the processor may generate customized fishery information including the identified image and the question-responding sentence, so as to provide the customized fishery information to user accounts through a chatbot system linked to the fishery information provision platform.

According to one embodiment, when the image identification is completed by performing the function of the image information identification step (step S601), the processor may generate customized fishery information including the identified image and the question-responding sentence.

In this regard, when the customized fishery information is completely generated, the processor may output the generated customized fishery information through the chatbot of the chatbot system pre-linked to the fishery information provision platform, thereby allowing the user of the user account to view images and question-responding sentences based on the customized fishery information output through the chatbot.

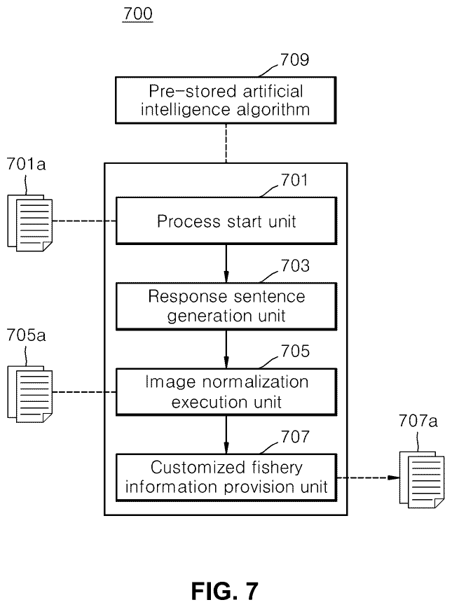

FIG. 7 is a block diagram for explaining the method for providing a chatbot service that outputs customized fishery information according to one embodiment of the present invention.

Referring to FIG. 7, a method implemented by a computing device including one or more processors and one or more memories for storing instructions executable in the processors to provide a chatbot service that outputs customized fishery information may include a process start unit 701 (ex: performing the same function as the process start step (step S101) of FIG. 1), a response sentence generation unit 703 (ex: performing the same function as the response sentence generation step (step S103) of FIG. 1), and an image normalization execution unit 705 and a customized fishery information provision unit 707 (ex: performing the same function as the customized fishery information provision step (step S105) of FIG. 1).

According to one embodiment, when a fishery-related question 701a is received from a user account registered as a member of a fishery information provision platform, the process start unit 701 may check user information registered in the user account, and start a service provision process for providing customized fishery information about the fishery-related question 701a based on the checked user information.

According to one embodiment, the fishery information provision platform may be a platform pre-linked with the chatbot system to provide customized fishery information to users registered as members through a chatbot of the chatbot system.

According to one embodiment, when the fishery-related question is received from the user account, the process start unit 701 may check user information registered in the user account.

In this regard, the user information refers to information containing detailed information written by the user of the user account, and may be information including environmental weather information (such as temperature, humidity, precipitation and sunlight in an aquaculture area), aquatic product growth information (such as growth rate, size and number of fish) marine environment information (such as water temperature, salinity and tidal current), fishery product distribution information (such as sales price and sales volume) and fishery log information (record on details of aquaculture work, time, weather, harvest volume and the like).

According to one embodiment, when the user information is checked, the process start unit 701 may perform a service provision process for analyzing the fishery-related question received from the user account based on the detailed information contained in the checked user information to provide customized fishery information.

According to one embodiment, the service provision process may be a process for providing a service that outputs the customized fishery information to a user account through a chatbot.

According to one embodiment, when the service provision process is started, the response sentence generation unit 703 may analyze the fishery-related question 701a through the pre-stored artificial intelligence algorithm 709, and apply the detailed information included in the user information as a vector weight, thereby generating a question-responding sentence for responding to the fishery-related question 701a.

According to one embodiment, when the service provision process is started, the response sentence generation unit 703 may analyze the fishery-related question 701a through the pre-stored artificial intelligence algorithm 709.

According to one embodiment, the response sentence generation unit 703 may analyze the fishery-related question 701a through the pre-stored artificial intelligence algorithm 709 to calculate a vector value for the fishery-related question.

The response sentence generation unit 703 may convert the detailed information contained in the user information into a vector weight through the pre-stored artificial intelligence algorithm 709, and apply the vector weight to the vector value of the fishery-related question 701a.

In other words, the response sentence generation unit 703 may analyze the fishery-related question 701a based on the detailed information contained in the user information, thereby generating a question-responding sentence for the fishery-related question 701a based on the detailed information contained in the user information.

In this regard, the question-responding sentence refers to a sentence for responding to the fishery-related question based on the detailed information contained in the user information, and may be a sentence that summarizes an answer or related news obtained through the pre-stored artificial intelligence algorithm.

According to one embodiment, when the question-responding sentence is completely generated, the image normalization execution unit 705 may identify images 705a corresponding to the fishery-related question 701a and the question-responding sentence through the pre-stored artificial intelligence algorithm 709, and may perform a normalizing process on the identified image 705a when the identified images satisfy preset tuning conditions.

According to one embodiment, when the images 705a corresponding to the fishery-related question and the question-responding sentence are completely identified, the image normalization execution unit 705 may determine whether an area included in the image 705a satisfies the preset tuning conditions.

Accordingly, when the area included in the image 705a is determined as satisfying the preset tuning conditions, the image normalization execution unit 705 may perform a normalizing process on the identified image 705a.

In this regard, the normalizing process may include at least one process of a mean normalization process of dividing pixel values of an image by an average value and then multiplying the divided pixel values by an original size to normalize, a standard deviation normalization process of dividing pixel values of an image by a standard deviation and multiplying the divided pixel values by an original size to normalize, a Min-Max normalization process of dividing pixel values of an image by minimum and maximum values and then multiplying the divided pixel values by an original size to normalize, a normalization map process of converting each pixel value of an image into a value between 0 and 1, a normalization map process of converting pixel values of an image into a mean and a standard deviation, and a principal component analysis (PCA) process of extracting and normalizing main components of an image.

According to one embodiment, when the normalizing process for the image 705a is completed, the customized fishery information provision unit 707 may generate customized fishery information 707a for the fishery-related question based on the normalized image and the question-responding sentence, and output the customized fishery information so as to be provided to the user account through the chatbot system of the fishery information provision platform.

According to one embodiment, when the normalization process of the image and the generation of the question-responding sentence are completed, the customized fishery information provision unit 707 may generate customized fishery information 707a including the image after the normalization process is completed and the question-responding sentence.

The generated customized fishery information may be information including a content and a normalized image generated based on a result obtained by analyzing the fishery-related question based on the user information.

According to one embodiment, when the customized fishery information 707a is completely generated, the customized fishery information provision unit 707 may output the generated customized fishery information 707a through a chatbot of a chatbot system pre-linked to the fishery information provision platform, thereby providing the content and the image based on the customized fishery information to the user account.

In other words, when the function of the image normalization execution unit 705 is completed, the customized fishery information provision unit 707 may generate customized fishery information including the normalized image and the question-responding sentence, so as to complete providing the customized fishery information to user accounts through a chatbot system linked to the fishery information provision platform.

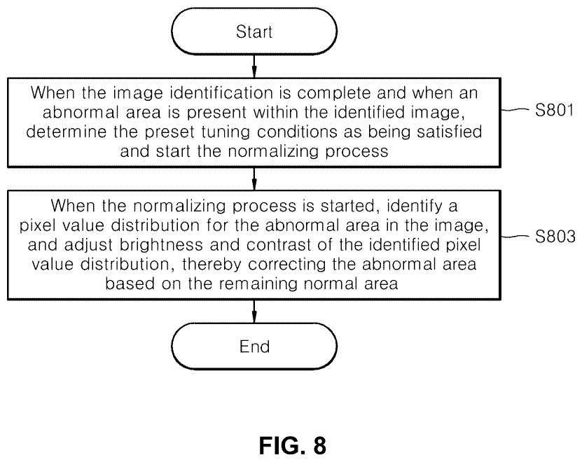

FIG. 8 is a flowchart for explaining an image normalization processing step of the method for providing a chatbot service that outputs customized fishery information according to one embodiment of the present invention.

Referring to FIG. 8, a method implemented by a computing device including one or more processors and one or more memories for storing instructions executable in the processors to provide a chatbot service that outputs customized fishery information may include an image normalization execution step (ex: performing the same function as the image normalization execution unit 705 of FIG. 7).

According to one embodiment, the image normalization execution step may be a step in which, when the question-responding sentence is completely generated, images corresponding to the fishery-related question and the question-responding sentence may be identified through the pre-stored artificial intelligence algorithm, thereby performing a normalizing process on the identified image when the identified images satisfy preset tuning conditions.

According to one embodiment, the image normalization execution step may include a normalizing process start step (step S801) and a normalizing correction completion step (step S803) as detailed steps for performing the above-described functions.

In step S801, when the image is completely identified and when an abnormal area is present within the identified image, the at least one processor (hereinafter referred to as “processor”) may determine the preset tuning conditions as being satisfied and start the normalizing process.

According to one embodiment, when the image is completely identified, the processor may analyze the image through the second model of the pre-stored artificial intelligence algorithm, thereby determining whether the abnormal area is present within the identified image.

In this regard, the abnormal area may include an abnormal resolution area, an abnormal brightness area, an object blurring area and the like positioned within the image.

According to one embodiment, the processor may analyze images included in papers and news articles based on question-responding sentence in addition to the multiple images stored in the image database, and may start the normalizing process for the abnormal area included in the images included in the papers and news articles based on the question-responding sentence when the preset tuning conditions are satisfied.

According to one embodiment, when the normalizing process is started, the processor may perform the normalizing correction completion step (step S803).

In step S803, when the normalizing process is started, the processor may identify a pixel value distribution for the abnormal area in the image, and adjust brightness and contrast of the identified pixel value distribution, thereby correcting the abnormal area based on the remaining normal area.

According to one embodiment, when the normalizing process for the image is started, the processor may identify the pixel value distribution for the abnormal area in the image to adjust the brightness and the contrast of the identified pixel value distribution. The adjusted setting values may be derived through the second model.

According to one embodiment, the processor may perform a normalizing process corresponding to a tuning condition satisfied to the abnormal area included in the image among the preset tuning conditions, thereby performing correction on the abnormal area, so that the abnormal area may be corrected based on the normal area of the image.

FIG. 9 is a diagram for explaining an example of an internal configuration of a computing device according to one embodiment of the present invention.

FIG. 9 shows one example of an internal configuration of a computing device according to one embodiment of the present invention. In the following description, unnecessary descriptions for embodiments redundant with those of FIGS. 1 to 8 will be omitted.

As shown in FIG. 9, the computing device 10000 may include at least one processor 11100, a memory 11200, a peripheral interface 11300, an input/output subsystem (I/O subsystem) 11400, a power circuit 11500, and a communication circuit 11600. The computing device 10000 may correspond to a user terminal A connected to a tactile interface device or correspond to the above-mentioned computing device B.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 10000.

The access to the memory 11200 from other components of the processor 11100 or the peripheral interface 11300, may be controlled by the processor 11100.

The peripheral interface 11300 may combine an input and/or output peripheral device of the computing device 10000 to the processor 11100 and the memory 11200. The processor 11100 may execute the software module or the instruction set stored in memory 11200, thereby performing various functions for the computing device 10000 and processing data.

The input/output subsystem 11400 may combine various input/output peripheral devices to the peripheral interface 11300. For example, the input/output subsystem 11400 may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem 11400.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or arbitrary other components for generating, managing, or distributing power.

The communication circuit 11600 may use at least one external port to enable communication with other computing devices.

Alternatively, as described above, if necessary the communication circuit 11600 may transmit and receive an RF signal, also known as an electromagnetic signal, including RF circuitry, thereby enabling communication with other computing devices.

The above embodiment of FIG. 9 is merely an example of the computing device 10000, and the computing device 11000 may have a configuration or arrangement in which some components shown in FIG. 9 are omitted, additional components not shown in FIG. 9 are further provided, or at least two components are combined. For example, a computing device for a communication terminal in a mobile environment may further include a touch screen, a sensor, and the like in addition to the components shown in FIG. 9, and the communication circuit 1160 may include a circuit for RF communication of various communication schemes (such as WiFi, 3G, LTE, Bluetooth, NFC, and Zigbee). The components that may be included in the computing device 10000 may be implemented by hardware, software, or a combination of both hardware and software which include at least one integrated circuit specialized in a signal processing or an application.

Methods according to embodiments of the present invention may be implemented in the form of program instructions to be executed through various computing devices so as to be recorded in a computer-readable medium. Particularly, a program according to the embodiment may be configured as a PC-based program or an application dedicated to a mobile terminal. The application to which the present invention is applied may be installed on a user terminal through a file provided by a file distribution system. For example, the file distribution system may include a file transmission unit (not shown) for transmitting the file according to a request of the user terminal.

The above-mentioned device may be implemented by hardware components, software components, and/or a combination of hardware components and software components. For example, the devices and components described in the embodiments, for example, may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it will be appreciated by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, and computer storage medium or device. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms so as to be recorded in a computer-readable medium. The computer-readable medium may include program instructions, data files, data structures, and the like, independently or in combination thereof. The program instructions recorded in the medium may be specially designed and configured for the embodiment, or may be known to those skilled in the art of computer software so as to be used. Examples of the computer-readable recording medium include a magnetic medium such as a hard disk, a floppy disk and a magnetic tape, an optical medium such as a CD-ROM and a DVD, a magneto-optical medium such as a floptical disk, and a hardware device, such as ROM, RAM and flash memory, specially configured to store and execute a program instruction. Examples of program instructions include a high-level language code to be executed by a computer using an interpreter or the like, as well as a machine code generated by a compiler. The above hardware device may be configured to operate as at least one software module to perform the operations of the embodiments, and vise versa.

Although the above embodiments have been described with reference to the limited embodiments and drawings, it will be understood by those skilled in the art that various changes and modifications may be made from the above-mentioned description. For example, appropriate results may be achieved even though the described techniques may be performed in an order different from the described manner, and/or the described components such as system, structure, device, and circuit may be coupled or combined in a form different from the described manner, or replaced or substituted by other components or equivalents. Therefore, other implementations, other embodiments, and equivalents to the claims are also within the scope of the following claims.

What is claimed is:

1. A method implemented by a computing device including one or more processors and one or more memories for storing instructions executable in the processors to provide a chatbot service that outputs customized fishery information, the method comprising:
a process start step, when a fishery-related question is received from a user account registered as a member of a fishery information provision platform, of checking user information registered in the user account, and starting a service provision process for providing customized fishery information about the fishery-related question based on the checked user information;
a response sentence generation step of analyzing the fishery-related question through a pre-stored artificial intelligence algorithm when the service provision process is started, and applying the detailed information included in the user information as a vector weight, thereby generating a question-responding sentence for responding to the fishery-related question; and
a customized fishery information provision step, when the question-responding sentence is completely generated, and images corresponding to the fishery-related question and the question-responding sentence are identified through the pre-stored artificial intelligence algorithm, of generating customized fishery information for the fishery-related question based on the identified image and the question-responding sentence, and outputting the customized fishery information so as to be provided to the user account through the chatbot system of the fishery information provision platform.

2. The method of claim 1, wherein the process start step includes:
a detailed information check step, when the fishery-related question is received from the user account, of checking environmental weather information, aquatic product growth information, marine environment information, aquatic product distribution information and aquatic product log information, which are detailed information included in the user information registered in the user account; and
an analysis start step, when a function of the detailed information check step is completed, of starting a service provision process for generating and providing customized fishery information by analyzing the fishery-related question based on the checked detailed information.

3. The method of claim 1, wherein the response sentence generation step includes:
a first tokenization step, when the service provision process is started, of performing a tokenization process on the fishery-related question through a first model of the pre-stored artificial intelligence algorithm, and tokenizing a first sentence corresponding to the fishery-related question; and
a vector value-based category identification step, when the first sentence is completely tokenized, of performing a vectorising process on the first token of the first sentence through the first model, and calculating a vector value for the first token digitized based on a position of the first token from the first sentence to calculate a vector value for the first sentence, thereby determining a category to which the first sentence is included among preset multiple categories through the calculated vector value.

4. The method of claim 3, wherein the response sentence generation step further includes:
a second tokenization step, when the service provision process is started, of performing a tokenization process on the detailed information included in the user information through a first model of the pre-stored artificial intelligence algorithm, and tokenizing each of second sentences corresponding to the detailed information included in the user information; and
a weight calculation classification step, when each of the second sentences is tokenized, of performing a vectorising process on the second token of each of the second sentences through the first model, calculating a vector value for the second token digitized based on a position of the second token from each of the second sentences, to calculate a vector value for each of the second sentences, and classifying the vector value for each of the second sentences by a weight to be applied to the vector value of the first sentence, so as to be classified by preset multiple categories.

5. The method of claim 4, wherein the preset categories include categories, which contain multiple reference sentences serving as candidates for responding to the fishery-related question while matching with a representative vector value for each of multiple categories, and include reference category information updated with multiple reference sentences included in each of the categories by an administrator of the fishery information provision platform, together with the representative vector values matching with the categories.

6. The method of claim 4, wherein the response sentence generation step further includes a response sentence derivation step, and the response sentence derivation step includes:
a vector value analysis step, when the vector value of the first sentence and the vector value of the second sentence are calculated, of starting an analysis on the vector value of the first sentence, the vector value of the second sentence, and the vector values of the reference sentences included in the category including the first sentence by using the first model of the pre-stored artificial intelligence algorithm;
a reference sentence identification step, when a function of the vector value analysis step is completed, of comparing the vector value of the first sentence with the reference vector value of each of the reference sentences included in the category including the first sentence among the preset categories, and applying the vector value of the second sentence classified by the weight to the vector value of the first sentence, so as to identify a reference sentence having a reference vector value having a high similarity to the vector value of the first sentence to which the weight is applied; and
a sentence derivation completion step, when the reference sentence is completely identified, of checking a part identified as a basis for the fishery-related question in the identified reference sentence to perform a summary process of summarizing the reference sentence through the first model, and then documenting the summarized reference sentence, thereby deriving and completing a question-responding sentence for responding to the fishery-related question.

7. The method of claim 1, wherein the customized fishery information provision step includes:
an image information identification step, when the question-responding sentence is completely generated, of analyzing the fishery-related question and the question-responding sentence through a second model of the pre-stored artificial intelligence algorithm, so that
at least one image corresponding to the result obtained by analyzing the fishery-related question and the question-responding sentence is identified among multiple image information stored in an image database; and
a chatbot-based information provision step, when the image is completely identified, of generating customized fishery information including the identified image and the question-responding sentence, and providing the customized fishery information to user accounts through a chatbot system linked to the fishery information provision platform.

8. The method of claim 1, wherein the pre-stored artificial intelligence algorithm includes:
a first model as a large-scale language model that learns a first pattern value derived by analyzing reference sentences included in multiple preset categories, other fishery-related questions for each of the preset categories, other users information registered in other user accounts having provided other fishery-related questions, and a correlation through natural language processing of other question-responding sentences that respond to the other fishery-related questions reflecting the other user information; and
a second model as an image searching model that learns a second pattern value derived by analyzing reference images included in each of the preset multiple categories, other fishery-related questions for each of the preset categories, other question-responding sentences responding to other fishery-related questions reflecting other user information, and a correlation between other images corresponding to the other fishery-related questions and the other question-responding sentences.

9. A method implemented by a computing device including one or more processors and one or more memories for storing instructions executable in the processors to provide a chatbot service that outputs customized fishery information, the method comprising:
a process start step, when a fishery-related question is received from a user account registered as a member of a fishery information provision platform, of checking user information registered in the user account, and starting a service provision process for providing customized fishery information about the fishery-related question based on the checked user information;
a response sentence generation step, when the service provision process is started, of analyzing the fishery-related question through a pre-stored artificial intelligence algorithm, so as to apply the detailed information included in the user information as a vector weight, thereby generating a question-responding sentence for responding to the fishery-related question;
an image normalization execution step, when the question-responding sentence is completely generated, of identifying images corresponding to the fishery-related question and the question-responding sentence through the pre-stored artificial intelligence algorithm, and performing a normalization process on the identified image when the identified images satisfy preset tuning conditions; and
a customized fishery information provision step, when the normalizing process for the image is completed, of generating customized fishery information for the fishery-related question based on the normalized image and the question-responding sentence, and outputting the customized fishery information so as to be provided to the user account through the chatbot system of the fishery information provision platform.

10. The method of claim 9, wherein the process start step includes:
a detailed information check step, when the fishery-related question is received from the user account, of checking environmental weather information, aquatic product growth information, marine environment information, aquatic product distribution information and aquatic product log information, which are detailed information included in the user information registered in the user account; and
an analysis start step, when a function of the detailed information check step is completed, of starting a service provision process for generating and providing customized fishery information by analyzing the fishery-related question based on the checked detailed information.

11. The method of claim 9, wherein the response sentence generation step includes:
a first tokenization step, when the service provision process is started, of performing a tokenization process on the fishery-related question through a first model of the pre-stored artificial intelligence algorithm, and tokenizing a first sentence corresponding to the fishery-related question; and
a vector value-based category identification step, when the first sentence is completely tokenized, of performing a vectorising process on the first token of the first sentence through the first model, and calculating a vector value for the first token digitized based on a position of the first token from the first sentence to calculate a vector value for the first sentence, thereby determining a category to which the first sentence is included among preset multiple categories through the calculated vector value.

12. The method of claim 11, wherein the response sentence generation step further includes:
a second tokenization step, when the service provision process is started, of performing a tokenization process on the detailed information included in the user information through a first model of the pre-stored artificial intelligence algorithm, and tokenizing each of second sentences corresponding to the detailed information included in the user information; and
a weight calculation classification step, when each of the second sentences is tokenized, of performing a vectorising process on a second token of each of the second sentences through the first model, calculating a vector value for the second token digitized based on a position of the second token from each of the second sentences to calculate a vector value for each of the second sentences, and classifying the vector value for each of the second sentences by a weight to be applied to the vector value of the first sentence, so as to be classified by preset multiple categories.

13. The method of claim 12, wherein the preset categories include categories, which contain multiple reference sentences serving as candidates for responding to the fishery-related question while matching with a representative vector value for each of multiple categories, and include reference category information updated with multiple reference sentences included in each of the categories by an administrator of the fishery information provision platform, together with the representative vector values matching with the categories.

14. The method of claim 12, wherein the response sentence generation step further includes a response sentence derivation step, and the response sentence derivation step includes:
a vector value analysis step, when the vector value of the first sentence and the vector value of the second sentence are calculated, of starting an analysis on the vector value of the first sentence, the vector value of the second sentence, and the vector values of the reference sentences included in the category including the first sentence by using the first model of the pre-stored artificial intelligence algorithm;
a reference sentence identification step, when a function of the vector value analysis step is completed, of comparing the vector value of the first sentence with the reference vector value of each of the reference sentences included in the category including the first sentence among the preset categories, and applying the vector value of the second sentence classified by the weight to the vector value of the first sentence, so as to identify a reference sentence having a reference vector value having a high similarity to the vector value of the first sentence to which the weight is applied; and
a sentence derivation completion step, when the reference sentence is completely identified, of checking a part identified as a basis for the fishery-related question in the identified reference sentence to perform a summary process of summarizing the reference sentence through the first model, and then documenting the summarized reference sentence, thereby deriving and completing a question-responding sentence for responding to the fishery-related question.

15. The method of claim 9, wherein the image normalization execution step includes:
a normalizing process start step, when the image is completely identified and when an abnormal area is present within the identified image, of determining the preset tuning conditions as being satisfied and start the normalizing process; and
a normalizing correction completion step, when the normalizing process is started, of identifying a pixel value distribution for the abnormal area in the image, and adjusting brightness and contrast of the identified pixel value distribution, thereby correcting the abnormal area based on the remaining normal area.

16. The method of claim 9, wherein the pre-stored artificial intelligence algorithm includes:
a first model as a large-scale language model that learns a first pattern value derived by analyzing reference sentences included in multiple preset categories, other fishery-related questions for each of the preset categories, other users information registered in other user accounts having provided other fishery-related questions, and a correlation through natural language processing of other question-responding sentences that respond to the other fishery-related questions reflecting the other user information; and
a second model as an image searching model that learns a second pattern value derived by analyzing reference images included in each of the preset multiple categories, other fishery-related questions for each of the preset categories, other question-responding sentences responding to other fishery-related questions reflecting other user information, and a correlation between other images corresponding to the other fishery-related questions and the other question-responding sentences.

17. A device implemented by a computing device including one or more processors and one or more memories for storing instructions executable in the processors to provide a chatbot service that outputs customized fishery information, the device comprising:
a process start unit, when a fishery-related question is received from a user account registered as a member of a fishery information provision platform, for checking user information registered in the user account, and starting a service provision process for providing customized fishery information about the fishery-related question based on the checked user information;
a response sentence generation unit, when the service provision process is started, for analyzing the fishery-related question through a pre-stored artificial intelligence algorithm, and applying the detailed information included in the user information as a vector weight, thereby generating a question-responding sentence for responding to the fishery-related question; and
a customized fishery information provision unit, when the question-responding sentence is completely generated, and when images corresponding to the fishery-related question and the question-responding sentence are identified through the pre-stored artificial intelligence algorithm, for generating customized fishery information for the fishery-related question based on the identified image and the question-responding sentence, and outputting the customized fishery information so as to be provided to the user account through the chatbot system of the fishery information provision platform.

18. A device implemented by a computing device including one or more processors and one or more memories for storing instructions executable in the processors to provide a chatbot service that outputs customized fishery information, the device comprising:
a process start unit, when a fishery-related question is received from a user account registered as a member of a fishery information provision platform, for checking user information registered in the user account, and starting a service provision process for providing customized fishery information about the fishery-related question based on the checked user information;
a response sentence generation unit, when the service provision process is started, for analyzing the fishery-related question through a pre-stored artificial intelligence algorithm, and applying the detailed information included in the user information as a vector weight, thereby generating a question-responding sentence for responding to the fishery-related question;
an image normalization execution unit, when the question-responding sentence is completely generated, for identifying images corresponding to the fishery-related question and the question-responding sentence through the pre-stored artificial intelligence algorithm, and performing a normalization process on the identified image when the identified images satisfy preset tuning conditions; and
a customized fishery information provision unit, when the normalizing process for the image is completed, for generating customized fishery information for the fishery-related question based on the normalized image and the question-responding sentence, and outputting the customized fishery information so as to be provided to the user account through the chatbot system of the fishery information provision platform.

19. A computer-readable recording medium storing instructions for allowing a computing device to perform the steps comprising:
a process start step, when a fishery-related question is received from a user account registered as a member of a fishery information provision platform, of checking user information registered in the user account, and starting a service provision process for providing customized fishery information about the fishery-related question based on the checked user information;
a response sentence generation step, when the service provision process is started, of analyzing the fishery-related question through a pre-stored artificial intelligence algorithm, and applying the detailed information included in the user information as a vector weight, thereby generating a question-responding sentence for responding to the fishery-related question; and
a customized fishery information provision step, when the question-responding sentence is completely generated, and when images corresponding to the fishery-related question and the question-responding sentence are identified through the pre-stored artificial intelligence algorithm, of generating customized fishery information for the fishery-related question based on the identified image and the question-responding sentence, and outputting the customized fishery information so as to be provided to the user account through the chatbot system of the fishery information provision platform.

20. A computer-readable recording medium storing instructions for allowing a computing device to perform the steps comprising:
a process start step, when a fishery-related question is received from a user account registered as a member of a fishery information provision platform, of checking user information registered in the user account, and starting a service provision process for providing customized fishery information about the fishery-related question based on the checked user information;
a response sentence generation step, when the service provision process is started, of analyzing the fishery-related question through a pre-stored artificial intelligence algorithm, and applying the detailed information included in the user information as a vector weight, thereby generating a question-responding sentence for responding to the fishery-related question;
an image normalization execution step, when the question-responding sentence is completely generated, of identifying images corresponding to the fishery-related question and the question-responding sentence through the pre-stored artificial intelligence algorithm, and performing a normalization process on the identified image when the identified images satisfy preset tuning conditions; and
a customized fishery information provision step, when the normalizing process for the image is completed, of generating customized fishery information for the fishery-related question based on the normalized image and the question-responding sentence, and outputting the customized fishery information so as to be provided to the user account through the chatbot system of the fishery information provision platform.
